(19) United States
(12) Patent Application Publication
(10) Pub. No.: US 2008/0018988 A1
(43) Pub. Date: Jan. 24, 2008

(54) Light source with tailored output spectrum

(76) Inventor: Andrew Davidson, Mountain View, CA (US)

Correspondence Address: THE LAW OFFICE OF STEVEN G ROEDER, 5560 CHELSEA AVE, LA JOLLA, CA, 92037, US

(21) Appl. No.: 11/491,785

(22) Filed: Jul. 24, 2006

(51) Int. Cl. H01S 3/00; H04B 10/12

(52) U.S. Cl. 359/341.1

(57) ABSTRACT

A light source assembly (10) for a precision apparatus (11) includes a broadband light generator (12), an amplifier (14), and an optical filter (16). The light generator (12) generates a generator beam (22) that is directed at the amplifier (14). The amplifier (14) provides an amplified beam (24) by amplifying the generator beam (22). The optical filter (16) filters both the generator beam (22) and the amplified beam (24) so that an output beam (20) has a specific spectral width and a specific center wavelength, and so that the power available from the amplifier is concentrated within the desired spectrum. With this design, the light source assembly (10) can provide an output beam (20) having a spectrum determined by the filter and power which is not strongly dependent on the spectrum. For example, the output can have a specific, relatively narrow spectral width and a specific center wavelength, with sufficient power for use in precision measurement systems (11). Additionally, the output beam (20) can have sufficient spectral width to eliminate unwanted interference effects.

### BACKGROUND

While optical systems often exploit the coherence of lasers to their advantage, they also can suffer from effects that result from the same high level of coherence. For example, fringes or speckle can degrade an image. Also, an interferometer that is designed to work at one path length difference can be influenced by interference effects caused by stray reflections at another path length difference. Thus, it can be advantageous to control the coherence properties of the light beam while staying within the designed wavelength range of the system. One type of coherence-controlled light source is a phase modulated laser. However, the phase modulated laser is limited by repetitive peaks in contrast and it is difficult to achieve short coherence lengths. Another type is a superluminescent diode. However, with this type of light source, the spectral width and center wavelength are not easily controllable.

### SUMMARY

A light source assembly for a precision apparatus includes a light generator, an amplifier, and an optical filter. The light generator generates a generator beam that is transferred to the amplifier. The amplifier provides an amplified beam. The optical filter filters the amplified beam so that an output beam has a specific spectral width and a specific center wavelength. The optical filter also reduces noise originating in the amplifier. With this design, in certain embodiments, the light source assembly can provide an output beam having a specific, relatively narrow spectral width and a specific center wavelength, with sufficient power for use in precision measurement systems. Additionally, in certain embodiments, the light source assembly generates an output beam with sufficient spectral width to eliminate unwanted interference effects.

In one embodiment, the optical filter also filters the generator beam. With this design, the same optical filter is used to filter both the generator beam and the amplified beam. Further, with this design, a filtered generator beam having a relatively narrow spectral width is directed to the amplifier. Stated in another fashion, the input to the amplifier has relatively narrow spectral width. This can improve the efficiency of the light source assembly.

Additionally, the light source assembly can include a circulator that receives the generator beam and that directs the generator beam at the optical filter. Further, the amplified beam that has been transmitted through the optical filter is directed to the circulator.

The present invention is also directed to a precision apparatus and a method for generating an output beam.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified schematic of a first embodiment of a precision apparatus including a light source assembly having features of the present invention;

FIG. 2 is a more detailed schematic of the light source assembly of FIG. 1;

FIG. 3 is a graph that illustrates the spectral output of two separate light source assemblies;

FIG. 4 is a graph that illustrates output power of an output beam versus input power to a light generator with four alternative, constant drive currents to a amplifier;

FIG. 5 is a graph that illustrates the spectral characteristics of the output beam with the placement of the optical filter at three alternative locations;

FIG. 6 is a graph that illustrates the spectral characteristics of the output beam with four different arrangements; and

FIG. 7 is a simplified illustration of another embodiment of a light source assembly.

### DESCRIPTION

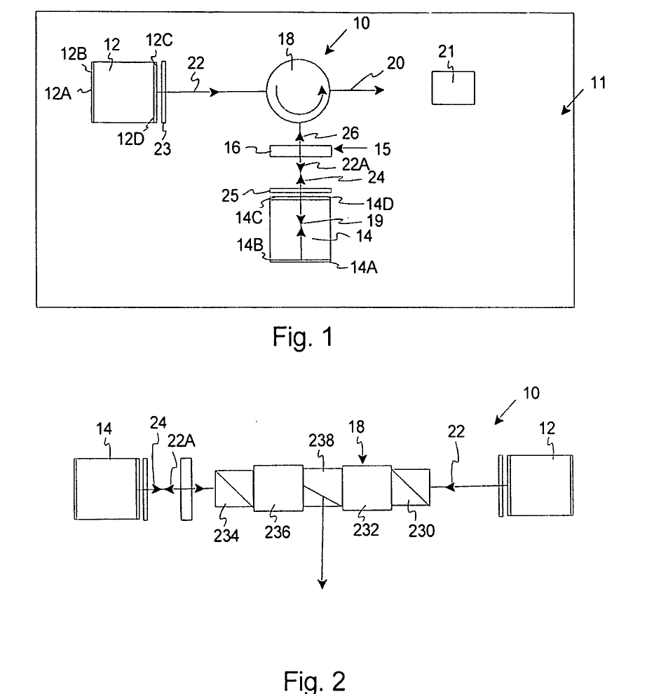

Referring initially to FIG. 1, the present invention is directed to a light source assembly 10 that can be used as part of a precision apparatus 11. Examples of a precision apparatus 11 that can use the light source assembly 10 include measurement instruments, scientific instruments and/or manufacturing equipment. For example, the light source assembly 10 can be used in an interferometer system.

In FIG. 1, the light source assembly 10 includes a light generator 12, an amplifier 14, a filter assembly 15 including at least one optical filter 16, and a circulator 18 that cooperate to generate an output beam 20 that is directed at a device 21. The design and orientation of the components of the precision apparatus 10 can be changed pursuant to the teachings provided herein. In one embodiment, the light source assembly 10 is a double pass amplifier configuration.

As an overview, in certain embodiments, the light source assembly 10 is uniquely designed so that the output beam 20 has a specific, relatively narrow spectral width and a specific center wavelength, with sufficient power for use in precision measurement systems. Further, in certain embodiments, the light source assembly 10 generates an output beam 20 with sufficient spectral width to eliminate unwanted interference effects. The light source assembly 10 can be used in systems with relatively tight spectral-width and/or center wavelength requirements. Further, the light source assembly 10 disclosed herein can eliminate the need for a phase modulator. Accordingly, the light source assembly 10 can be easier to control.

The light generator 12 generates a generator beam 22 that is directed at the circulator 18. In one embodiment, the light generator 12 is a diode that functions as a superluminescent diode (“SLD”). In certain embodiments, the light generator 12 is designed so that the generator beam 22 has a center wavelength of between approximately 630 and 640 nm, and/or an output power of between approximately 1 and 20 milliwatts. For example, the generator beam 22 can have a center wavelength of approximately 633 nm, and/or an output power of approximately 10 milliwatts. Alternatively, the light generator 12 can be designed so that the generator beam 22 has a center wavelength and/or an output power that is greater or lesser than the values detailed above.

In certain embodiments, the light generator 12 is a broadband light source and the generator beam 22 has a spectrum of greater than approximately 1 nm.

One non-exclusive example of a suitable light generator 12 is a 635-nm, AlGaInP, multiple quantum well active layer laser diodes with output facet AR coated.

In one embodiment, the light generator 12 includes a first side 12A that is coated with a high reflection (“HR”) coating 12B and a second side 12C that is coated with an anti-reflection (“AR”) coating 12D. The HR coating 12B reflects light that is directed at the first side 12A back into the gain medium. The AR coating 12D allows light directed at the second side 12C to easily exit the light generator 12. With this design, the AR coating 12D inhibits lasing. One or both of the sides 12A, 12C can be angled to enhance performance of the light generator 12.

Additionally, the light source assembly 10 can include a first optical element 23 that collimates and focuses the first generated beam 22. For example, the first optical element 23 can include one or more optical lens.

The amplifier 14 generates an amplified beam 24 that is directed at the optical filter 16. In one embodiment, the amplifier 14 is a diode that functions as a semiconductor optical amplifier. In certain embodiments, the amplifier 14 is designed so that the amplified beam 24 has a center wavelength of between approximately 630 and 640 nm, and/or an output power of between approximately 10 and 50 milliwatts. For example, the amplified beam 24 can have a center wavelength of between approximately 633 nm, and/or an output power of approximately 20 milliwatts. Alternatively, the amplifier 14 can be designed so that the amplified beam 24 has a center wavelength and/or an output power that is greater or lesser than the values detailed above.

In one embodiment, the amplifier 14 includes a first side 14C that is coated with an anti-reflection (“AR”) coating 14D and a second side 14A that is coated with a high-reflection (“HR”) coating 14B. The HR coating 14B reflects light that is directed at the first side 14A back into the gain medium. The AR coating 14D allows light directed at the second side 14C to easily exit the amplifier 14. With this design, the AR coating 14D inhibits lasing. One or both of the sides 14A, 14C can be angled to enhance performance of the amplifier 14.

Additionally, the light source assembly 10 can include a second optical element 25 that collimates and focuses the amplified beam 24. For example, the second optical element 25 can include one or more optical lens.

In one embodiment, the amplifier 14 is a double pass amplifier. For example, the amplifier 14 can include a waveguide. In the embodiment illustrated in FIG. 1, the filtered generator beam 22A enters the first side 14C of the amplifier 14 and follows a tightly controlled path 19 in the amplifier 14. Next, the partly amplified beam is reflected off of the second side 14A of the amplifier 14 back through the amplifier along the same tightly controlled path 19 until the amplified beam 24 exits the first side 14C of the amplifier 14.

One non-exclusive example of a suitable amplifier 14 is a 635-nm, AlGaInP, multiple quantum well active layer laser diodes with output facet AR coated.

In FIG. 1, the generator beam 22 is collimated with the first optical element 23 and the amplified beam 24 is collimated with the second optical element 25. The focus of only one or both of the optical elements 23, 25 can be actively adjusted to optimize coupling.

The filter assembly 15 filters the generator beam 22 from the light generator 12 that is directed at the amplifier 14, and filters the amplified beam 24 from the amplifier 14 that is directed towards the circulator 18. The portion of the light generator beam 12 that passes through the filter assembly 15 is referred to as a filtered generator beam 22A. Further, the portion of the amplified beam 24 that passes through the filter assembly 15 is referred to herein as the transmitted beam 26. The transmitted beam 26 is subsequently directed at the circulator 18. In one embodiment, the filter assembly 15 includes only one optical filter 16 and the generator beam 22 and the amplified beam 24 are both directed at the optical filter 16. With this design, (i) the same optical filter 16 filters both the generator beam 12 and the amplified beam 24 and (ii) the generator beam 12 and the amplified beam 24 follow the same path through the optical filter 16 but in opposite directions. This can reduce the size, cost, and/or complexity of the light source assembly 10.

In one embodiment, the filter assembly 15 precisely controls both the center wavelength and the spectral width of the transmitted beam 26. Further, the design of the filter assembly 15 can be precisely tailored to achieve the desired center wavelength and spectral width of the output beam 20. In one embodiment, the optical filter 16 is a band pass type filter that transmits a band of wavelengths (“the passband”) and blocks wavelengths outside of the passband. The passband has a center wavelength that is at the center of the passband. For example, in alternative non-exclusive embodiments, the filter is a narrow band pass filter with a passband having a bandwidth of approximately 0.1, 0.5, 1, 1.5, 2, or 5 nanometers. As a result thereof, the transmitted beam 26 has a precisely controlled, relatively narrow spectral width.

Further, the transition from transmitting to rejection can be sharp. In alternative, non-exclusive embodiments, the filter 16 has a spectral slope capable of transitioning between 10% and 90% transmission in less than 0.2 nm, 0.5 nm, 1 nm, or 5 nm.

Additionally, the optical filter 16 is designed so that the center wavelength of the passband is near the desired wavelength for operation of the precision apparatus 11. With this design, the optical filter 16 passively controls the transmitted beam 26 to have the desired center wavelength and a relatively narrow spectral width. Moreover, the filtering of the amplified beam 24 reduces any noise originating in the amplifier 14 that lies outside of the passband. Further, the input, e.g. the filtered generator beam 22A to the amplifier 14 has the desired spectral width. This concentrates the available power of the amplifier 14 in the desired spectrum to improve the efficiency of the amplifier 14. Stated in another fashion, in-band light does not compete with out-of band light for gain from the amplifier 14.

In certain embodiments, the optical filter 16 can be moved, e.g. rotated, to precisely fine tune the center wavelength. One non-exclusive example of a suitable, optical filter 16 is model number LL01-633 sold by Semrock, located in Rochester, N.Y.

It is noted that other, possibly more complicated filter 16 types could be used instead of a bandpass filter. An example is that of a filter 16 to compensate the naturally peaked gains of the generator 12 and amplifier 14 so that the spectrum of the transmitted beam is flatter and/or broader than that if the filter 16 were not present. It is also noted that the filter 16 could have a variable, controllable shape. Such variable filters 16 are achieved by various means, such as by spatially modulating a spectrally dispersed beam, and would allow the selection of a desired spectrum with arbitrary shape.

The circulator 18 (i) receives the generator beam 22 from the light generator 12, (ii) directs the generator beam 22 at the optical filter 16, (iii) receives the transmitted beam 26 from the optical filter 16, (iv) directs the output beam 20 toward the device 21, (v) provides isolation between the amplifier 14 and the generator 12, and (vi) provides isolation between the amplifier 14 and the device 21. One embodiment of the circulator 18 is described in more detail below.

In certain embodiments, the temperature of light generator 12, the amplifier 14 and/or other components of the light source assembly 10 can be actively controlled.

FIG. 2 is a more detailed schematic of the light source assembly 10 of FIG. 1. More specifically, FIG. 2 illustrates one non-exclusive embodiment, of the circulator 18 in more detail, as well as the light generator 12 and the amplifier 14. In this embodiment, the circulator 18 includes a first polarization beamsplitter cube (PBS) 230, a first faraday rotator 232, a second polarization beamsplitter cube 234, a second faraday rotator 236, and a center polarization beamsplitter cube 238. Alternatively, for example, the circulator 18 could have another design. For example, the one or more of the polarization beamsplitter cubes could be replaced with a different type of polarization splitter.

Each of the first, second and center Polarizing Beamsplitter cubes 230, 234 split randomly polarized beams into two orthogonal, linearly polarized components. Each of the first, second and center Polarizing Beamsplitter cubes 230, 234, 238 can consist of a pair of precision high tolerance right angle prisms cemented together with a dielectric coating on the hypotenuse of one of prisms.

The center Polarizing Beamsplitter cube 238 is at 45 degrees. Waveplates could be used to manipulate polarization if this 45 degree angle is undesirable. Each of the faraday rotators 232, 236 is an optical device that rotates the polarization of light due to the Faraday effect.

In one embodiment, one of the light generator 12 and the amplifier 14 operates in a TM mode and produces an elliptical beam and the other one of the light generator 12 and the amplifier 14 operates in a TE mode and also produces an elliptical beam. In this embodiment, the faraday rotators 232, 236 are configured so that each rotate polarization 45 degrees in the same direction to produce a total of 90 degrees of rotation. This allows mode matching with respect to both ellipse orientation and polarization, helping to optimize coupling of light from the light generator 12 to the amplifier 14.

If the light generator 12 and the amplifier 14 have similar polarization (both TE or both TM), the faraday rotators 232, 236 can be configured to rotate polarization in opposite directions to produce a total of zero degrees of rotation. This could eliminate the need for a waveplate to achieve mode matching.

The implementation shown in FIG. 2 provides two stages of isolation between the light generator 12 and the amplifier 14, and one stage of isolation between the output beam 20 and the amplifier 14. It is also possible that a circulator 18 with a single Faraday rotator be used. In this embodiment, only one stage of isolation is present between the light generator 12 and the amplifier 14. Whether or not one stage of isolation is sufficient will depend on the gain of the light generator 12 and the amplifier 14. In general, if the round-trip loss of the cavity terminated by the light generator 12 and the amplifier 14 is too low (or, alternatively, if too much light from the amplifier 14 leaks back to the light generator 12), then spectral ripple could result (or in extreme cases, oscillation). In cases where one stage of isolation is sufficient, then it may be desirable due to lower cost.

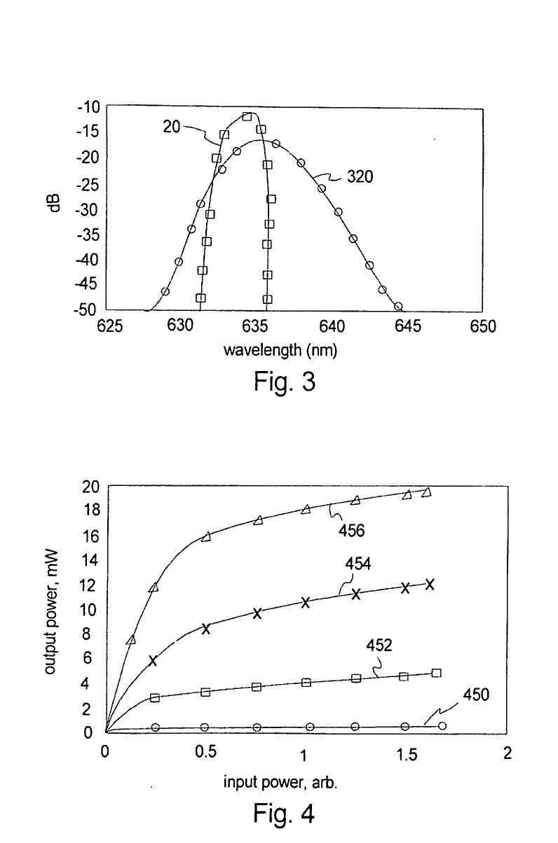

FIG. 3 is a graph that illustrates the spectral features of the output beam 20 of the light source assembly 10 of FIG. 1 versus the spectral features of an output beam 320 of a light source assembly that does not include the optical filter 16. In this example, because of the optical filter 16, the optical beam 20 has a relatively narrow spectral width when compared to the optical beam 320 that has not been filtered. Further, because of the optical filter 16 and because of saturation of the amplifier, the optical beam 20 has increased power spectral density.

With the light source assembly 10 illustrated in FIG. 1, because the amplifier 14 is operated in a saturated state, reducing the filter bandwidth (and hence the input power) does not lead to a proportionately lower output power of the optical beam 20. This is illustrated in FIG. 3 by the increased power spectral density for the optical beam 20 from the light source assembly 10 with the filter 16. As a result of this behavior, most of the power available from a given amplifier can be extracted such that little power is sacrificed even with fairly narrow filters 16.

In FIG. 3, the optical beam 20 has a center wavelength of approximately 633 nm and a spectral width of approximately 1.7 nm. However, the filter 16 could be designed to have a wider or narrower spectral width and/or the center wavelength can be controlled to any level desired if needed by angle tuning of the optical filter.

FIG. 4 is a graph that illustrates output power of the output beam 20 (illustrated in FIG. 1) versus input power from the light generator 12 (illustrated in FIG. 1) for four alternative, constant drive currents to the amplifier 14 (illustrated in FIG. 1). In FIG. 4, line 450 represents a constant current of 55 mA—directed to the amplifier 14; line 452 represents a constant current of 70 mA directed to the amplifier 14; line 454 represents a constant current of 85 mA directed to the amplifier 14; and line 456 represents a constant current of 100 mA directed to the amplifier 14. The light generator 12 is driven at 90 mA.

FIG. 4 illustrates how the amplifier 14 saturates for the light source assembly 10 illustrated in FIG. 1. As input power to the amplifier 14 is increased beyond about 0.2-0.5 on the arbitrary scale, further increases of input power do not produce proportionate increases of output power. With such saturation behavior, reducing input power to the amplifier 14 (for example, by using a narrower filter to filter the input generator light) by a factor of two from 1.5 to 0.75 results in a reduction of output power of only about 10%. Thus, output power is not very sensitive to filter width and in certain embodiments, it is not necessary to sacrifice high power to obtain a narrow spectrum.

In certain embodiments, a possible benefit of amplifying the generator beam 22 is the ability to run the light generator 12 at lower drive levels. This can result in less ripple in the spectrum of the output beam 20. At higher drive levels of the light generator 12, the high gain combined with the residual reflection from the AR coating can produce significant ripple that produces peaks in the contrast vs. optical-path-length-difference plots. Because the amplifier is largely saturated, its small signal gain is low and it is less prone to producing ripple. Thus, it is the light generator 12 that dictates the level of ripple. Accordingly, in certain embodiments, the present invention provides a way to produce enough power while operating the light generator 12 at relatively low drive levels.

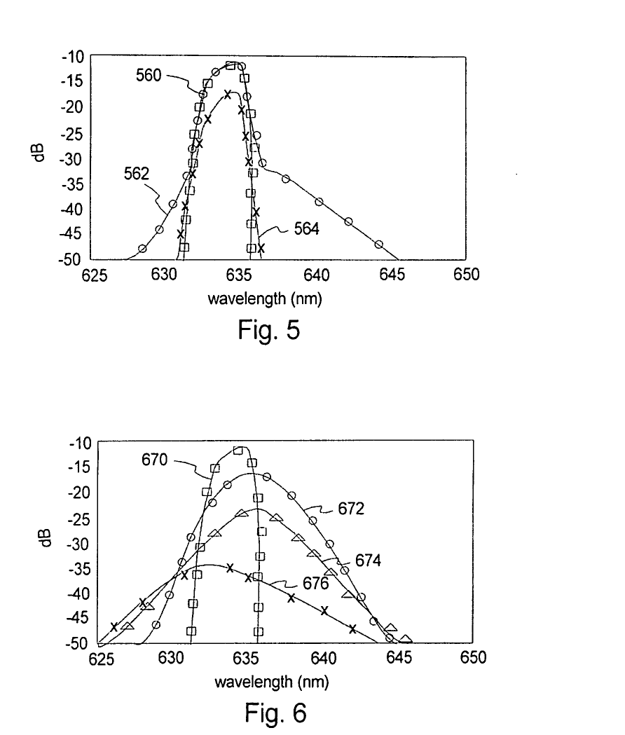

FIG. 5 is a graph that illustrates the spectral characteristics of the output beam with the placement of the optical filter at three alternative locations. More specifically, line 560 represents the output beam for a light source assembly 10 similar to that illustrated in FIG. 1; line 562 represents the output beam for a light source assembly (not shown) with the optical filter positioned between the light generator and the circulator (instead of between the amplifier and the circulator as illustrated in FIG. 1); and line 564 represents the output beam for a light source assembly (not shown) with the optical filter positioned after the circulator (instead of between the amplifier and the circulator as illustrated in FIG. 1). For output beam 560 and output beam 562, the in-band light does not compete with out-of band light for amplifier gain, so the resulting power is approximately 5 dB higher. For output beam 560, the spontaneous emission from the amplifier (amplifier) is filtered. Alternatively, for output beam 562, the amplified spontaneous emission (“ASE”) from the amplifier (amplifier) is present in the output beam 562. Thus, in this example, the best position for the optical filter 16 is between the amplifier 14 and the circulator 18 as illustrated in FIG. 1. In FIG. 5, the light generator and the amplifier are driven at 90 mA.

FIG. 6 is a graph that illustrates the spectral characteristics of the output beam with four different arrangements. More specifically, line 670 represents the output beam for a light source assembly 10 similar to that illustrated in FIG. 1; line 672 represents the output beam for a light source assembly 10 without the optical filter; line 674 represents the output beam for a light source assembly (not shown) without the optical filter, without the light generator, but with the amplifier; and line 676 represents the output beam for a light source assembly (not shown) without the optical filter, with the amplifier removed and replaced by a mirror, but with the light generator. FIG. 6 illustrates that the output beam 670 has good power and a narrow spectral width when compared with the light generator and amplifier separately.

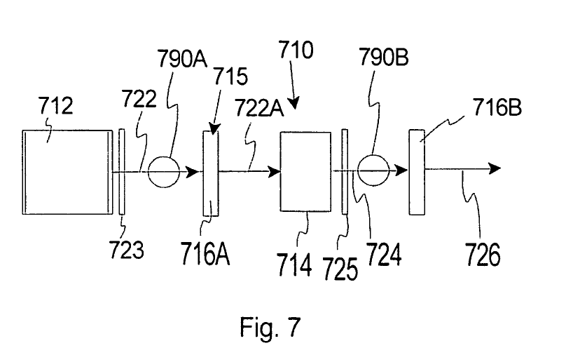

FIG. 7 is a simplified illustration of another embodiment of a light source assembly 710 that is somewhat similar to the light source assembly 10 described above. However, in this embodiment, the filter assembly 715 includes a first optical filter 716A and a second optical filter 716B, and the amplifier 714 is a two-port, single pass amplifier. In this embodiment, each of the optical filters 716A, 716B is a narrow pass band filter. With this design, the light generator 712 directs the first generator beam 722 at the first optical filter 716A through the first optical element 723. The first generator beam 722 is filtered by the first optical filter 716A and the filtered generator beam 722 is directed at the amplifier 714 to be amplified. Next, the amplified beam 724 is directed at the second optical filter 716B through the second optical element 725. Finally, the amplified beam 724 is filtered by the second optical filter 716B and the transmitted beam 726 can be directed at the device 21 (illustrated in FIG. 1).

Additionally, the light source assembly 710 can include one or more optical isolators 790A, 790B. In the embodiment illustrated in FIG. 7, the light source assembly 710 includes a first optical isolator 790A positioned between the light generator 712 and the first optical filter 716A, and a second optical isolator 790B positioned between the amplifier 714 and the second optical filter 716B. In another embodiment, the optical isolators 790A, 790B can be alternatively located in the light source assembly 710. Each of the optical isolators 790A, 790B can include a faraday rotator.

While the particular apparatus 10 as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A light source assembly comprising:
a filter assembly including at least one optical filter;
a light generator that generates a broadband generator beam that is transferred to the filter assembly to create a filtered generator beam; and
an amplifier that receives the filtered generator beam and creates an amplified beam.

2. The light source assembly of claim 1 wherein the amplified beam is transferred to the filter assembly to create a transmitted beam.

3. The light source assembly of claim 1 wherein the optical filter is a band pass filter.

4. The light source assembly of claim 1 wherein the optical filter is a band pass filter having a pass band that is less than approximately five nm.

5. The light source assembly of claim 1 wherein the spectral response of the filter is variable and controllable.

6. The light source assembly of claim 1 further comprising a circulator that receives the generator beam and that directs the generator beam at the filter assembly.

7. The light source assembly of claim 6 wherein the amplified beam is transferred to the filter assembly to create a transmitted beam that is transferred to the circulator.

8. The light source assembly of claim 7 wherein the circulator directs the transmitted beam as an output beam at a device.

9. The light source assembly of claim 7 wherein the spectral response of the filter is variable and controllable.

10. The light source assembly of claim 1 further comprising an isolator that receives the generator beam and that directs the generator beam at the filter assembly.

11. A light source assembly comprising:
a filter assembly including at least one optical filter;
a light generator that generates a broadband generator beam that is transferred to the filter assembly to create a filtered generator beam; and
a double pass amplifier that receives the filtered generator beam and creates an amplified beam that is transferred to the optical filter to create a transmitted beam, wherein the generator beam and the amplified beam are both filtered by the same optical filter.

12. The light source assembly of claim 11 wherein the filter is a band pass filter.

13. The light source assembly of claim 12 wherein the band pass filter has a pass band that is less than approximately five nm.

14. The light source assembly of claim 11 wherein the spectral response of the filter is variable and controllable.

15. The light source assembly of claim 11 further comprising a circulator that receives the generator beam and that directs the generator beam at the filter assembly.

16. The light source assembly of claim 15 wherein the transmitted beam is transferred to the circulator.

17. The light source assembly of claim 16 wherein the circulator directs an output beam at a device.

18. The light source assembly of claim 15 wherein the spectral response of the filter is variable and controllable.

19. The light source assembly of claim 11 wherein the filtered generator beam enters the amplifier, propagates through the gain medium, is reflected, then propagates again through the gain medium.

20. A method directing an output beam at a device, the method comprising the steps of:
generating a broadband generator beam with a light generator;
filtering the generator beam with a filter assembly to create a filtered generator beam, the filter assembly including at least one optical filter; and
amplifying the filtered generator beam with an amplifier to create an amplified beam.

21. The method of claim 20 further comprising the step of filtering the amplified beam with the filter assembly to create a transmitted beam.

22. The method of claim 20 wherein the step of filtering includes filtering with a band pass filter.

23. The method of claim 20 wherein the spectral response of the filter is variable and controllable.

24. The method of claim 20 further comprising the step of directing the generator beam at the filter assembly with a circulator.

25. The method of claim 24 further comprising the step of filtering the amplified beam with the filter assembly to create a transmitted beam and directing the transmitted beam to the circulator.

26. The method of claim 24 wherein the spectral response of the filter assembly is variable and controllable.
